(19) United States
(12) Patent Application Publication
(10) Pub. No.: US 2026/0006328 A1
(43) Pub. Date: Jan. 1, 2026

(54) FOCUS DETECTION APPARATUS AND FOCUS DETECTION METHOD

(71) Applicant: CANON KABUSHIKI KAISHA, Tokyo (JP)

(72) Inventor: KOJI INOUE, Tokyo (JP)

(21) Appl. No.: 19/247,013

(22) Filed: Jun. 24, 2025

(30) Foreign Application Priority Data
Jun. 27, 2024 (JP) 2024-104354

(51) Int. Cl. H04N 23/67; H04N 23/611; H04N 23/667

(52) U.S. Cl. CPC H04N 23/675; H04N 23/611; H04N 23/667; H04N 23/672

(57) ABSTRACT

A focus detection apparatus hierarchically detects one or more specific region from an object in a captured image, sets focus detection regions divided into a plurality of regions with respect to the specific region, detects focus detection information for each focus detection region, decides a target region for performing an automatic focus operation, obtains a distribution of defocus amount of the specific region, and changes a range for obtaining a distribution of defocus amount of a lower level region in a case where a distribution of defocus amount of an upper level region is not less than a predetermined range, when deciding the target region included in the upper level region based on the distribution of defocus amount of the lower level region in the specific region.

### BACKGROUND

### FIELD OF THE TECHNOLOGY

The present disclosure relates to a focus detection technique.

### Description of the Related Art

Japanese Patent Laid Open No. 2006-227080 describes a method of setting a focus detection region including a face region, which is a region to be more focused than others, when a person targeted for an autofocus control is detected. Japanese Patent Laid Open No.2001-215403 describes a method of detecting a pupil of a person who is a region to be more focused than others among focus detection regions including a face region and setting a focus detection region centered on the pupil. In recent years, the capability to detect a pupil of a person has also been improved, and the pupil can be detected even in a state where a face faces sideways.

In Japanese Patent Laid Open Nos.2006-227080 and 2001-215403, when the focus detection region centered on the pupil is set with respect to a face of which a person faces sideways, there is a possibility that the focus detection region includes a region other than the face region of the person. In such a case, the focus detection result is affected by including a high contrast object other than the face region of the person in the face region of the person. In addition, when the focus detection region centered on the pupil is included in the face region, the effect on the focus position is small even if the movement of the object or the hand shake of the photographer occurs, but when the focus detection region centered on the pupil is set with respect to the face of which the person faces sideways, the effect on the focus position is large because the face region included in the focus detection region centered on the pupil and the region other than the face region fluctuate.

### SUMMARY

The present disclosure has been made in consideration of the aforementioned problems, and realizes a technique capable of continuously focusing on the same object even when an orientation of an object targeted for automatic focus control changes.

The present disclosure is directed to a focus detection apparatus comprising: an object detection unit configured to hierarchically detect one or more specific region from an object in a captured image; a setting unit configured to set focus detection regions divided into a plurality of regions with respect to the specific region; a focus detection unit configured to detect focus detection information for each focus detection region; and a decision unit configured to decide a target region for performing an automatic focus operation, wherein the decision unit obtains a distribution of defocus amount of the specific region, and changes a range for obtaining a distribution of defocus amount of a lower level region in a case where a distribution of defocus amount of an upper level region is not less than a predetermined range, when deciding the target region included in the upper level region based on the distribution of defocus amount of the lower level region in the specific region.

The present disclosure is directed to a focus detection method comprising: hierarchically detecting one or more specific region from an object in a captured image; setting focus detection regions divided into a plurality of regions with respect to the specific region; detecting focus detection information for each focus detection region; and deciding a target region for performing an automatic focus operation, wherein in the deciding, a distribution of defocus amount of the specific region is obtained, and a range for obtaining a distribution of defocus amount of a tower level region is changed in a case where a distribution of defocus amount of an upper level region is not less than a predetermined range, when deciding the target region included in the upper level region based on the distribution of defocus amount of the lower level region in the specific region. Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

Fig. 1 is a block diagram showing the configuration of an image capture apparatus according to a present embodiment;

FIG. 2 is a flowchart illustrating control processing during shooting of the image capture apparatus according to the present embodiment;

FIG. 3 is a flowchart illustrating AF frame setting processing in the control processing during shooting according to the present embodiment;

FIGS. 4A and 4B are views illustrating a single specific region detected from an object and AF frames set in the specific region, respectively, according to the present embodiment;

FIGS. 5A and 5B are views illustrating a plurality of specific regions detected from an object and AF frames set in each specific region, respectively, according to the present embodiment;

FIG. 6 is a flowchart illustrating an AF operation in the control processing during shooting according to the present embodiment;

FIG. 7 is a flowchart illustrating focus detection processing in the AF operation according to the present embodiment;

FIG. 8 is a flowchart illustrating main frame selection processing in the AF operation according to the present embodiment;

FIG. 9 is a flowchart illustrating detected object main frame selection processing in the main frame selection processing according to the present embodiment;

FIG. 10 is a flowchart illustrating main frame selection region decision processing in the detected object main frame selection processing according to the present embodiment;

FIG. 11 is a flowchart illustrating pupil priority main frame selection processing in the main frame selection processing according to the present embodiment;

FIG. 12 is a view illustrating a histogram generation method in the pupil priority main frame selection processing according to the present embodiment;

FIG. 13 is a view illustrating AF frames around a pupil region in the pupil priority main frame selection processing according to the present embodiment;

FIG. 14 is a view illustrating AF frames around a pupil region in a facial profile in the pupil priority main frame selection processing according to the present embodiment; and

FIG. 15 is a view illustrating a histogram generated in the pupil priority main frame selection processing according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

An example will be described below in which a focus detection apparatus and an image capture apparatus according to the present disclosure are applied to an interchangeable lens digital camera. However, the present disclosure is not limited to this example, and the focus detection apparatus and the image capture apparatus may be applied to, for example, an integrated lens digital camera, a digital video camera, a smartphone having a camera function, a tablet computer, a web camera such as a monitoring camera, a medical camera, or the like.

An image capture apparatus according to a present embodiment includes the focus detection apparatus according to the present disclosure, and performs automatic focus (AF) control by an imaging plane phase difference detection method based on a pair of imaging signals from an imaging unit.

### <APPARATUS CONFIGURATION>

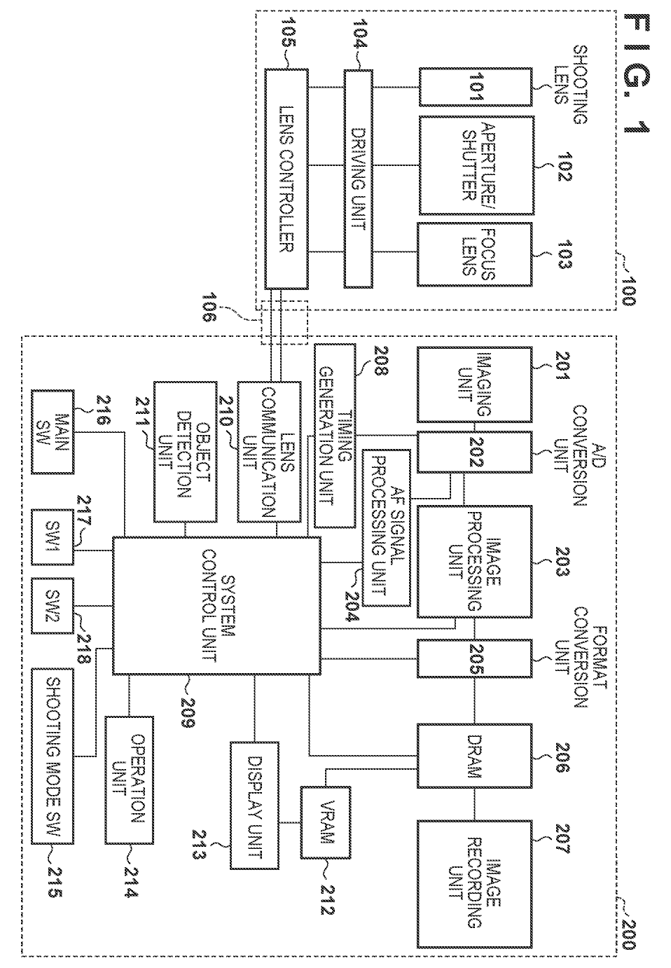

First, with reference to FIG. 1, the hardware configuration of the image capture apparatus according to the present embodiment will be described.

FIG. 1 is a block diagram illustrating the hardware configuration of the image capture apparatus according to the present embodiment.

The image capture apparatus according to the present embodiment includes a lens apparatus (interchangeable lens) 100 and a camera main body 200. The lens apparatus 100 is mechanically and electronically connected to a lens mount 106 of the camera main body 200. When the lens apparatus 100 is attached to the camera main body 200 via the lens mount 106, a lens controller 105 that comprehensively controls the operation of the lens apparatus 100 and a system control unit 209 that comprehensively controls the operation of the whole camera can communicate with each other. The lens mount 106 includes a transmission path (bus) that allows transmission and reception of a synchronization signal, a control signal, various kinds of data, and the like with the camera main body 200.

The lens apparatus 100 constitutes a shooting optical system that forms anoptical image of an object, which is tight reflected by the object, on an imaging unit 201 of the camera main body 200. The lens apparatus 100 includes a shooting lens 101 including a zooming mechanism, an aperture/shutter 102 that adjusts the light amount of the object image with respect to the imaging unit 201, a focus lens 103 that adjusts the focus state of the object image with respect to the imaging unit 201, a driving unit 104 such as motors that drive the shooting lens 101, the aperture/shutter 102, and the focus lens 103, and the lens controller 105.

The lens apparatus 100 communicates with the system control unit 209 of the camera main body 200 via the lens mount 106. The lens controller 105 controls the driving unit 104 to operate the aperture/shutter 102 for adjusting the brightness of the object image, and to displace the focus lens 103 for controlling the focus state of the object image.

The camera main body 200 captures the object image having passed through the shooting optical system of the lens apparatus 100, and generates an imaging signal.

The imaging unit 201 uses an image sensor such as a CCD or CMOS sensor to convert the object image formed on the light receiving plane into an electric signal, and outputs it to an A/D conversion unit 202. The A/D conversion unit 202 converts the analog signal input from the imaging unit 201 into a digital signal. The A/D conversion unit 202 includes a CDS circuit that removes noise from the analog signal, and a nonlinear amplification circuit for nonlinearly amplifying the analog signal before converting it into a digital signal.

An image processing unit 203 performs resizing processing, such as predetermined pixel interpolation and image reduction, and color conversion processing on the digital signal output from the A/D conversion unit 202, and outputs image data. The image processing unit 203 also performs predetermined arithmetic processing using the image data, and the system control unit 209 performs AF processing and AE (automatic exposure) processing based on the aritlunetic result.

Each pixel of the imaging unit 201 according to the present embodiment includes a plurality of (a pair of) photoelectric conversion elements (photodiodes) A and B, and one microlens provided for the pair of photoelectric conversion elements A and B. Each pixel divides incident light by the microlens to form a pair of optical images for the pair of photoelectric conversion elements A and B, and outputs a pair of pixel signals (A signal and B signal), which are used for focus detection signals to be described later, from the pair of photoelectric conversion elements A and B. By adding the outputs of the pair of photoelectric conversion elements A and B, an imaging signal (A signal + B signal) is obtained.

By synthesizing a plurality of A signals and a plurality of B signals, respectively, output from a plurality of pixels, a pair of image signals are obtained as focus detection signals that are used for AF by an imaging plane phase difference detection method (to be referred to as imaging plane phase difference AF hereinafter). An AF signal processing unit 204 performs correlation calculation on the pair of image signals to calculate the phase difference (to be referred to as an image shift amount hereinafter), which is the shift amount between the pair of image signals, and calculates, from the image shift amount, the defocus amount (and the defocus direction and reliability) of the shooting optical system. When a plurality of specific regions are detected from the object detected by an object detection unit 211, the AF signal processing unit 204 calculates the defocus amount in each specific region, and calculates a defocus distribution based on the calculated defocus amounts.

A format conversion unit 205 converts the format of the image data generated by the image processing unit 203 to store the image data in a DRAM 206. The DRAM 206 is an example of a high-speed internal memory, and used as a high-speed buffer for temporarily storing image data, a working memory during compression/decompression processing of image data, or the like.

An image recording unit 207 includes a recording medium such as a memory card for recording shot images (still image and moving image) and its interface.

A timing generation unit 208 supplies a clock signal and a control signal to the imaging unit 201 and the A/D conversion unit 202. By controlling the reset timing of charges accumulated in the imaging unit 201, the timing generation unit 208 can control the charge accumulation and discharge operation in the imaging unit 201.

The system control unit 209 includes a processor (CPU), memories (RAM and ROM), an input/output circuit, a timer circuit, and the like, and controls the operation of the whole apparatus by the CPU deploying a program stored in the ROM to the working area of the RAM and executing the program.

A lens communication unit 210 communicates with the lens controller 105 of the lens apparatus 100 attached to the camera main body 200 via the lens mount 106.

The object detection unit 211 executes known object detection processing on the imaging signals output from the A/D conversion unit 202, and detects an object existing in an image capture screen corresponding to the image data generated by the image processing unit 203. The object detection unit 211 can repeatedly detect one or a plurality of specific regions in the object in an image in a stepwise manner from an upper level region to a lower level region. When the object is a person, the specific regions are, for example, the whole body as the first hierarchical region, the face as the second hierarchical region included in the first hierarchical region, and the pupil as the third hierarchical region included in the second hierarchical region. Note that the object is not limited to a person, and may be an animal, a vehicle, a train, or the like. The specific region may be decided based on the features of the object.

A VRAM 212 is a video memory in which data for displaying on a display unit 213 is drawn. When the data generated in the VRAM 212 is transferred to the display unit 213 in accordance with a predetermined frame rate, an image is displayed on the display unit 213.

The display unit 213 includes a liquid crystal panel, an organic panel, or the like, and displays an image, operational assistance, the state of the camera, and the like. In addition, during shooting, the display unit 213 displays an image capture screen and an AF frame indicating a focus detection region.

A shooting person operates the image capture apparatus by an operation unit 214. The operation unit 214 includes, for example, a menu switch for setting various kinds of settings such as setting of exposure correction and an aperture value, setting at the time of image reproduction, and the like, a zoom lever for instructing the zoom operation of the shooting lens, and an operation mode change switch between a shooting mode and a reproduction mode.

A shooting mode switch (SW) 215 includes a shooting mode change switch for selecting a shooting mode such as a macro mode or a sports mode.

A main switch (SW) 216 is a switch for powering on the system. A first switch(SW) 217 is a switch for outputting a first switch signal SW1 to the system control unit 209 to perform a shooting preparation operation such as AE processing and AF processing. A second switch (SW) 218 is a switch for outputting a second switch signal SW2 to the system control unit 209 while the first switch signal SW1 is set in the ON state (shooting preparation state) by the first switch 217, thereby making a shooting instruction.

### <CONTROL PROCESSING DURING SHOOTING>

Next, with reference to , control processing during shooting according to the present embodiment will be described.

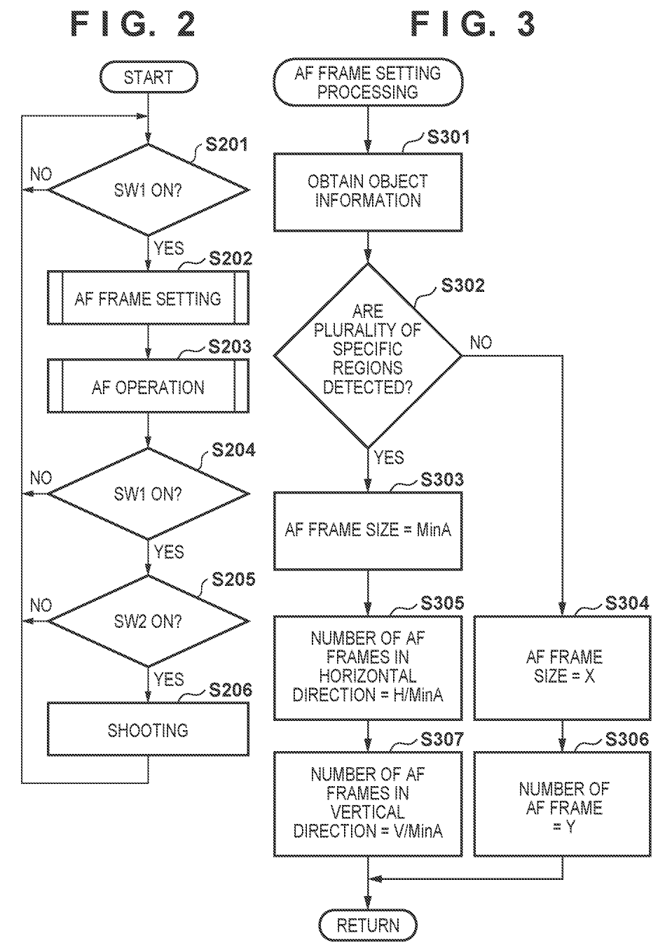

FIG. 2 is a flowchart illustrating AF control processing in a still image shooting mode according to the present embodiment.

Control processing according to the present embodiment is implemented by the system control unit 209 loading the program stored in the ROM to the RAM and executing the program, thereby controlling respective components of the lens apparatus 100 and the camera main body 200.

Note that in the present embodiment, AF control processing in the still image shooting mode will be described, but the control processing is also effective for a moving image servo AF in which, in a moving image shooting mode, a focus is continuously set on a specific object irrespective of a user operation.

In step S201, the system control unit 209 determines whether a shooting preparation instruction is accepted via the first switch 217. The system control unit 209 determines whether the first switch signal SW1 is ON. When the first switch signal SW1 is not ON, the system control unit 209 continues determination. When the first switch signal SW1 is ON, the system control unit 209 advances the processing to step S202.

In step S202, the system control unit 209 performs AF frame setting processing, which will be described later, and advances the processing to step S203.

In step S203, the system control unit 209 performs an AF operation, which will be described later, and advances the processing to step

In step S204, the system control unit 209 determines whether the first switch signal SW1 is ON. When the first switch signal SW1 is not ON, the system control unit 209 returns the processing to step S201. When the first switch signal SW1 is ON, the system control unit 209 advances the processing to step S205.

In step S205, the system control unit 209 determines whether a shooting instruction is accepted via the second switch 218. The system control unit 209 determines whether the second switch signal SW2 is ON. When the second switch signal SW2 is not ON, the system control unit 209 returns the processing to step S201. When the second switch signal SW2 is ON, the system control unit 209 advances the processing to step S206.

In step S206, the system control unit 209 performs shooting processing, and returns the processing to step S201.

### <AF FRAME SETTING PROCESSING>

FIG. 3 is a flowchart illustrating the AF frame setting processing in step S202 of FIG. 2.

In step 5301, the system control unit 209 obtains detected object information from the object detection unit 211. In the object detection processing in the present embodiment, the detection target is a person, and one or a plurality of specific regions in the object as the detection target are hierarchically detected. In the present embodiment, the whole body as the first hierarchical region, the face as the second hierarchical region, and the pupil as the third hierarchical region are detected.

As a method of detecting the object and the specific region, machine learning such as deep learning, image recognition processing, or the like can be used.

Examples of machine learning include the following types.

(1) Support Vector Machine

(2) Convolutional Neural Network

(3) Recurrent Neural Network

Examples of image recognition processing include a method of detecting a face by extracting feature points of the face such as eyes, a nose, and a mouth using a known pattern recognition technique. Note that the method of detecting the specific region is not limited to these examples, and may use another method.

In step S302, based on the detected object information obtained from the object detection unit 211, the system control unit 209 determines whether a plurality of specific regions are detected. When a plurality of specific regions are detected, the system control unit 209 advances the processing to step S303; otherwise, advances the processing to step S304.

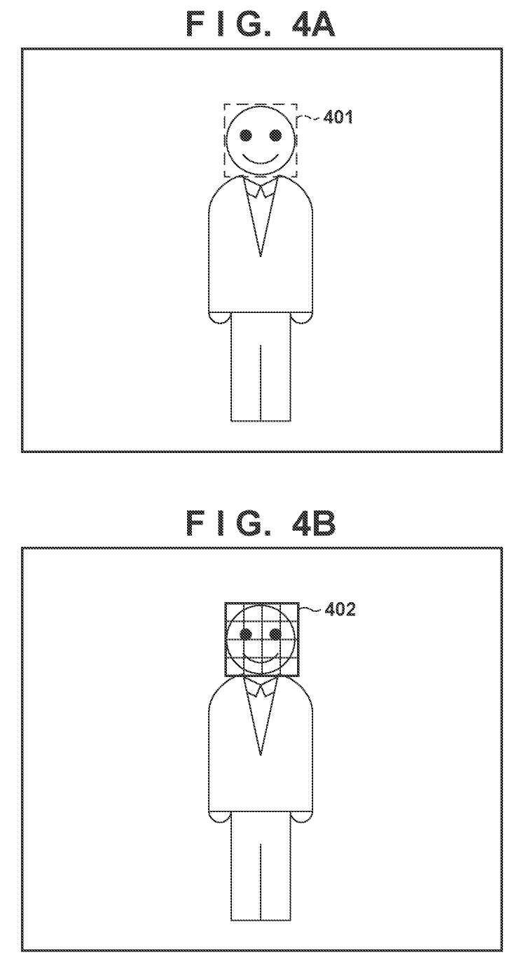

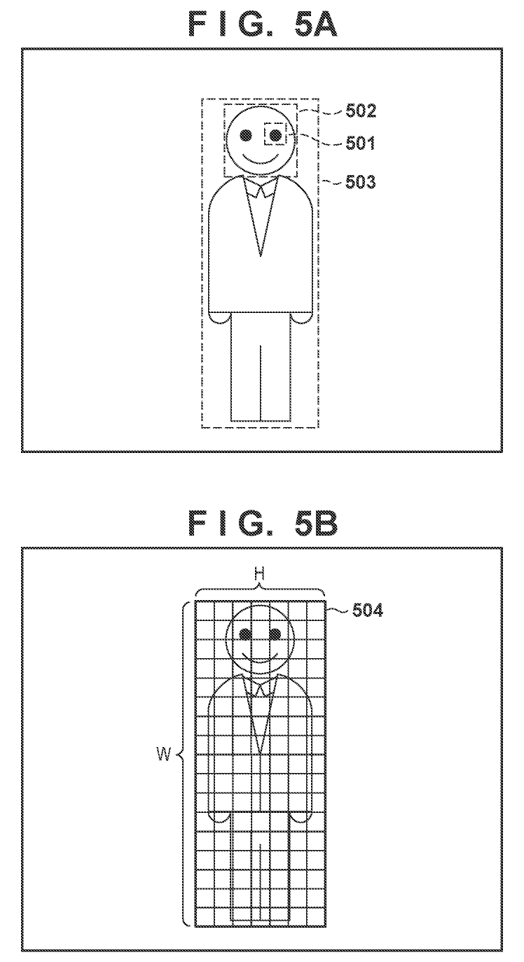

Here, with reference to FIGS. 4A and 4B and FIGS. 5A and SB, a state in which specific region detection is performed once and a single specific region is detected from the detected object, and a state in which specific region detection is repeatedly performed a plurality of times and a plurality of specific regions are detected from the detected object will be described.

FIG. 4A illustrates a state in which only a face 401 is detected as a specific region. FIG. 5A illustrates a state in which a pupil 501, a face 502, and a whole body 503 are detected as specific regions. The object detection unit 211 obtains the type of the object such as a person or an animal, and the center coordinates, horizontal size, and vertical size of the specific region detected from the object.

In step S303, the system control unit 209 sets the size of the AF frame to MinA, which is the size of the smallest region of the specific regions. In the example shown in Figs. SA and SB, the value of the smaller one of the horizontal size and vertical size of the pupil 501 is set as MinA, and the set MinA is set as the size of one AF frame 504.

In step S305, the system control unit 209 obtains, from the horizontal coordinates and horizontal sizes of the respective specific regions, a horizontal size H in Fig. SB that includes all the specific regions. By dividing the horizontal size H by the AF frame size MinA, the number of AF frames in the horizontal direction is decided.

In step S307, the system control unit 209 obtains, from the vertical coordinates and vertical sizes of the respective specific regions, a vertical size W in Fig. SB that includes all the specific regions. By dividing the vertical size V by the AF frame size MinA, the number ofAF frames in the vertical direction is decided. Then, the AF frame setting processing is terminated.

In the present embodiment, the square AF frame size is set using the minimum size of the specific region. However, the AF frame size may be different between the horizontal size and the vertical size. The number of AF frames may be set up to the number that the system control unit 209 can calculate.

In step S304, the system control unit 209 sets an AF frame of a predetermined size X with respect to the detected specific region. In the present embodiment, for example, as shown in FIGS. 4A and 4B, if the face 401 is detected as a specific region, an AF frame 402 of a size X according to the pupil size estimated from the face 401 is set. Note that in consideration of a low illuminance environment, an AF frame size that can ensure an S/N ratio and provide sufficient focusing performance may be set.

In step S306, the system control unit 209 sets the number of AF frames Y that allow the detected specific region to be included with the AF frame size set in step S304, and that can cope with a case where the specific region moves, and terminates the AF frame setting processing. In the present embodiment, for example, the system control unit 209 sets the number of AF frames Y that include the region of the face 401 in FIG. 4A and can cope with a case where the face 401 moves.

Note that the AF frame setting processing according to the present embodiment may be executed each time image data is input, or may be executed once each time image data is input multiple times. In this case, the set AF frame may be stored in the DRAM 206, and when the AF frame setting processing is not executed, the AF frame stored at the temporal closest timing may be read out and used.

### <AF OPERATION>

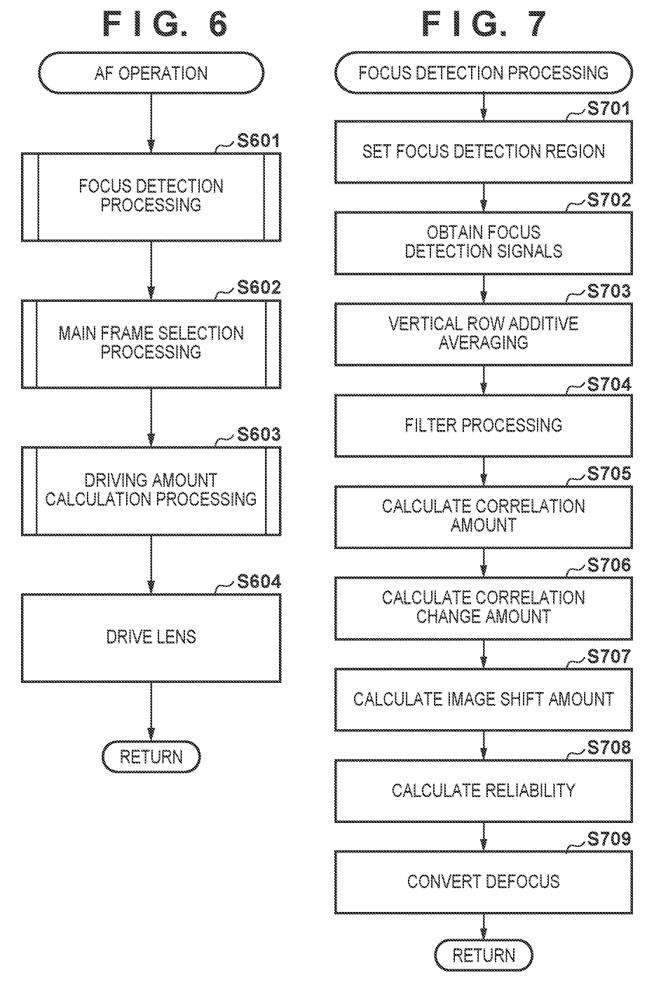

FIG. 6 is a flowchart illustrating the AF operation in step S203 of FIG. 2.

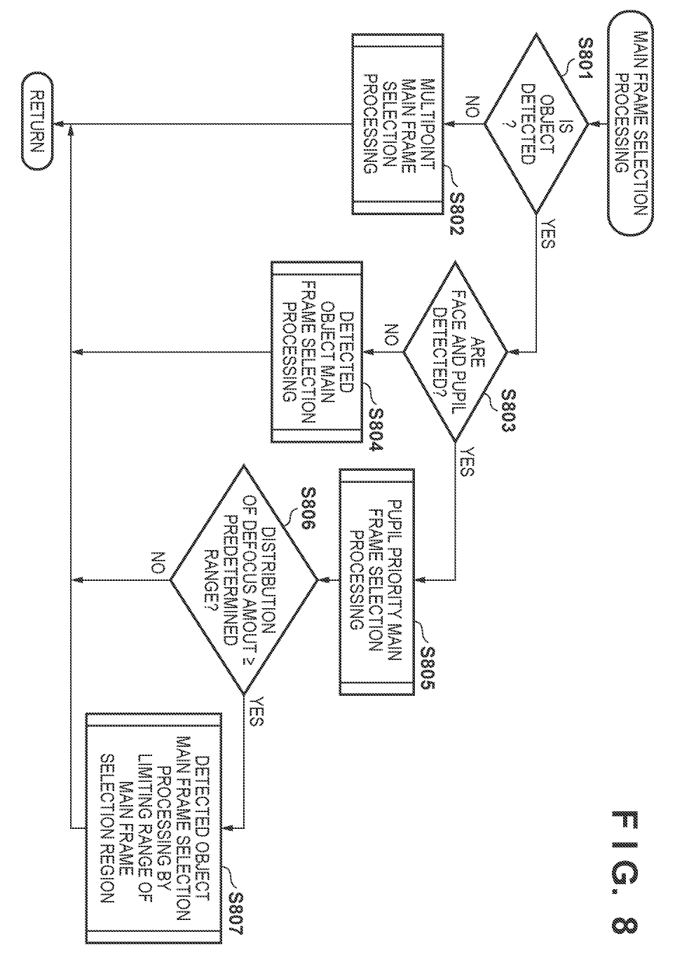

In step S601, the system control unit 209 performs focus detection processing, calculates a defocus amount by the AF signal processing unit 204, and advances the processing to step S602. Details of the focus detection processing will be described later with reference to FIG. 7.

In step S602, the system control unit 209 performs main frame selection processing based on the detected object information obtained in step S301 of FIG. 3, and advances the processing to step S603. Details of the main frame selection processing will be described later with reference to FIG. 8.

In step S603, the system control unit 209 calculates the driving amount of the focus lens based on the defocus amount of the main frame selected in step S602, and advances the processing to step S604. The main frame is a target region of the AF operation.

In step S604, the system control unit 209 transmits the focus lens driving amount calculated in step S603 to the lens apparatus 100 via the lens communication unit 210. The lens controller 105 of the lens apparatus 100 drives the focus lens 103 based on the focus lens driving amount received from the system control unit 209. FIG. 7 is a flowchart illustrating the focus detection processing in step S601 of FIG. 6.

### <FOCUS DETECTION PROCESSING>

FIG. 7 is a flowchart illustrating the focus detection processing in step S601 of FIG. 6.

In step S701, the system control unit 209 sets a focus detection region of a predetermined range in the image capture screen corresponding to the image data, and advances the processing to step S702.

In step S702, the system control unit 209 obtains, by the AF signal processing unit 204, focus detection information (A signal and B signal) from the focus detection region set in step S701, and advances the processing to step S703. In step S703, the system control unit 209 performs, in vertical direction, row additive averaging processing of the focus detection signals obtained in step S702, and advances the processing to step S704. With this processing, the influence of the noise of the focus detection signals can be reduced.

In step S703, the system control unit 209 performs, in vertical direction, row additive averaging processing of the focus detection signals obtained in step S702, and advances the processing to step S704. With this processing, the influence of the noise of the focus detection signals can be reduced.

In step S704, the system control unit 209 performs filter processing of extracting a signal component in a predetermined frequency band from the signals obtained by the vertical row additive averaging processing in step S703, and advances the processing to step S705.

In step S705, the system control unit 209 calculates a correlation amount from the signals having undergone the filter processing in step S704, and advances the processing to step S706.

In step S706, the system control unit 209 calculates a correlation change amount from the correlation amounts calculated in step S705, and advances the processing to step S707.

In step S707, the system control unit 209 calculates an image shift amount from the correlation change amounts calculated in step S706, and advances the processing to step S708.

In step S708, the system control unit 209 calculates the reliability of the image shift amount calculated in step S707, and advances the processing to step S709. In step S709, the system control unit 209 converts the image shift amount calculated in step S707 into a defocus amount, and terminates the processing.

### <MAIN FRAME SELECTION PROCESSING>

FIG. 8 is a flowchart illustrating the main frame selection processing in step S602 of FIG. 6.

In step S801, the system control unit 209 determines whether an object is detected by the object detection unit 211. When an object is detected, the system control unit 209 advances the processing to step S803. When no object is detected, the system control unit 209 advances the processing to step S802.

In step S802, since no object is detected by the object detection unit 211, the system control unit 209 performs multipoint main frame selection processing that does not use detected object information, and terminates the processing. As the multipoint main frame selection processing, for example, a method of selecting a main frame in a predetermined region in the image capture screen can be used, but a detailed description will be omitted.

In step S803, the system control unit 209 determines whether a face and a pupil are detected as the specific regions of the object detected by the object detection unit 211. When the face and the pupil are detected, the system control unit 209 advances the processing to step S805. When the face and the pupil are not detected, the system control unit 209 advances the processing to step S804.

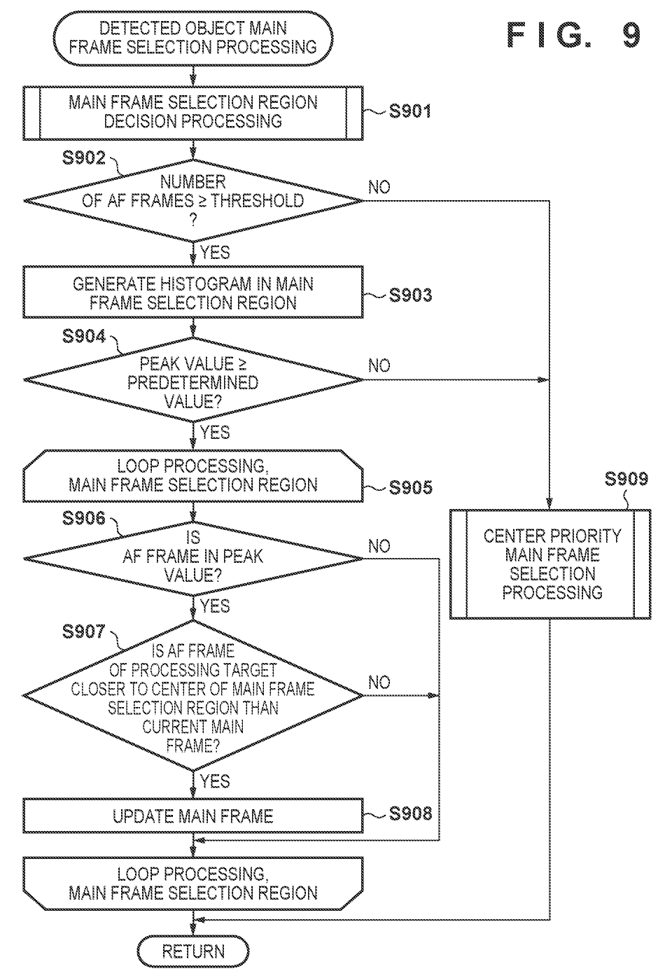

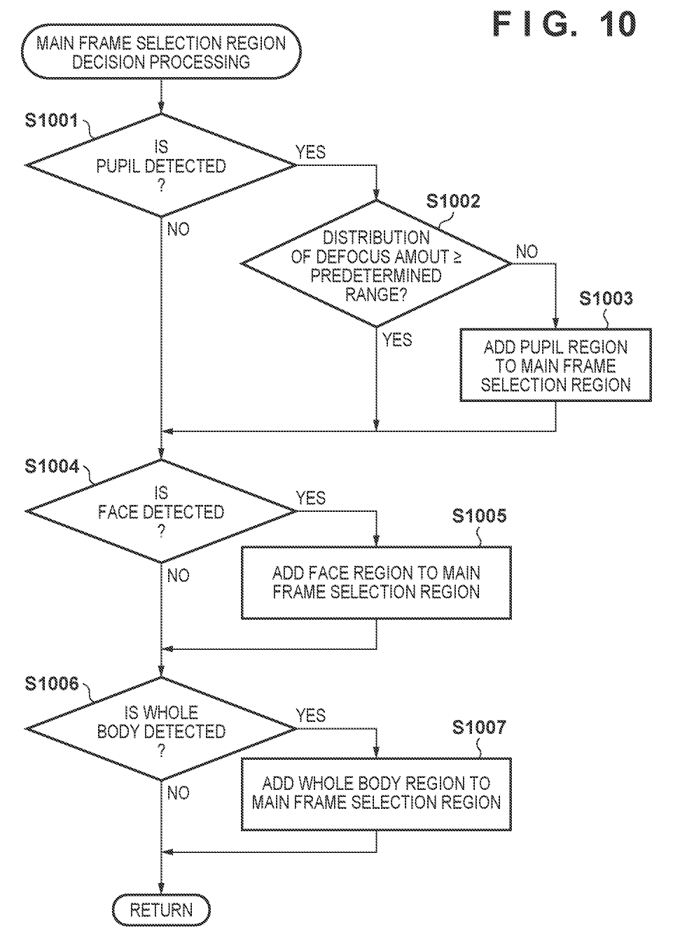

In step S804, the system control unit 209 performs detected object main frame selection processing, and terminates the processing. Details of the detected object main frame selection processing will be described later with reference to FIG. 9.

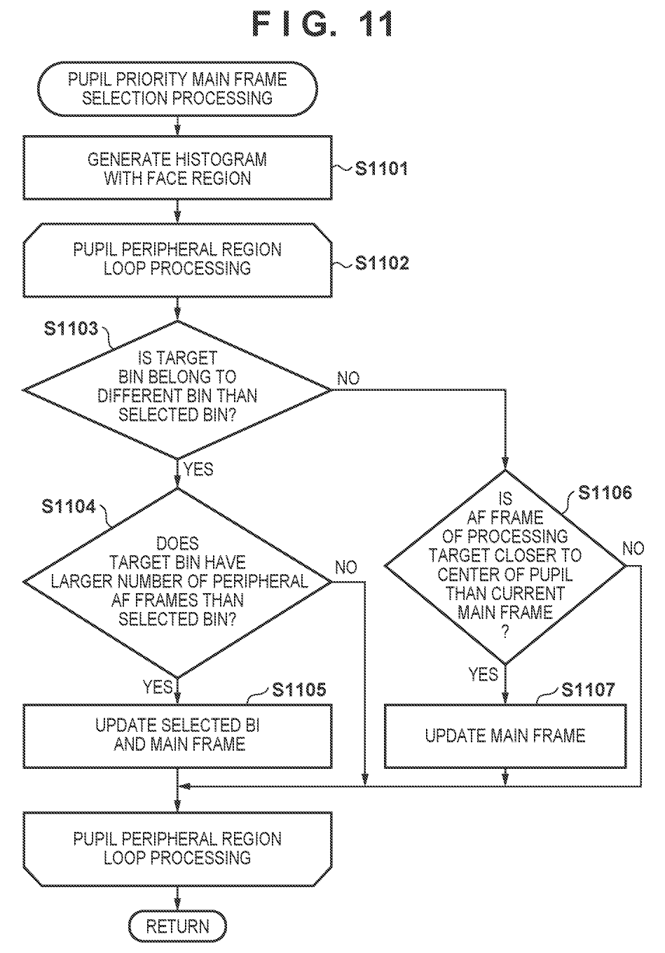

In step S805, the system control unit 209 performs pupil priority main frame selection processing, and advances the processing to step S806. Details of the pupil priority main frame selection processing will be described later with reference to FIG. 11.

In step S806, the system control unit 209 determines whether the distribution of defocus amount of the pupil region calculated in the pupil priority main frame selection processing in step S805 is not less than a predetermined range. When the distribution of defocus amount of the pupil region is less than the predetermined range, the system control unit 209 determines that the variation of the defocus amount is small, and advances the processing to step S603 of FIG. 6, and when the distribution of defocus amount of the pupil region is not less than the predetermined range, advances the processing to step S807.

In step S807, the system control unit 209 determines that the distribution of defocus amount of the pupil region is not within the predetermined range or more, the variation in the defocus amount is large, and there is a possibility that a perspective conflict with a background, etc. has occurred, and performs detected object main frame selection processing such that the range of the main frame selection region is limited in the main frame selection region determination processing which will described later with reference to FIG. 10, and terminates the processing.

### <DETECTED OBJECT MAIN FRAME SELECTION PROCESSING>

FIG. 9 is a flowchart illustrating the detected object main frame selection processing in steps S804 and S807 of FIG. 8.

In step S901, the system control unit 209 performs main frame selection region decision processing for deciding a main frame selection target region. Here, with reference to FIG. 10, the main frame selection region decision processing will be described.

In step S1001, the system control unit 209 determines whether a pupil is detected as the specific region of the object detected by the object detection unit 211. When a pupil is detected, the system control unit 209 advances the processing to step S1002. When a pupil is not detected, the system control unit 209 advances the processing to step S1004.

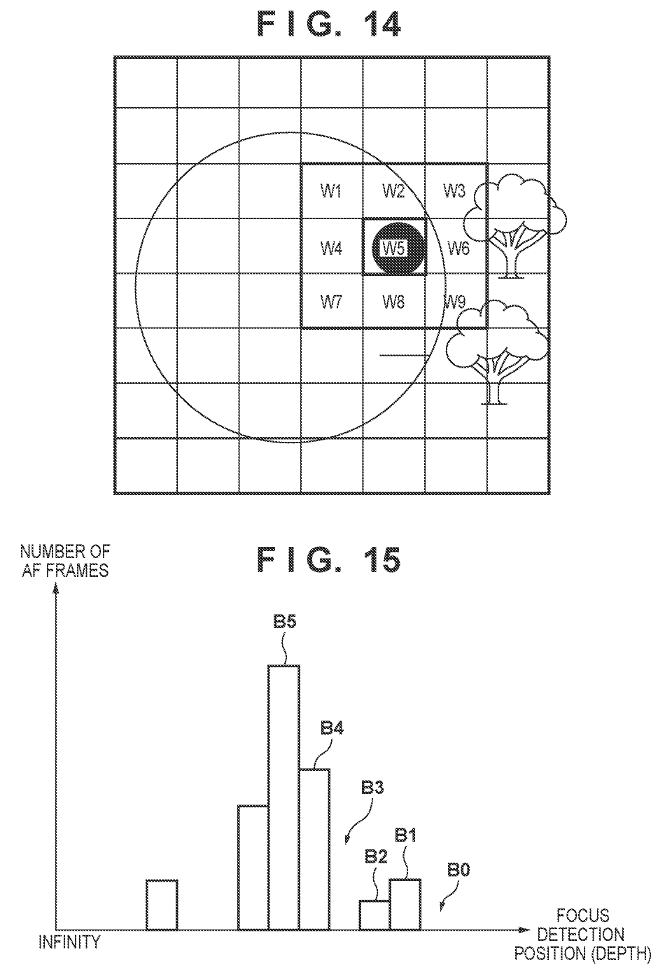

In step S1002, the system control unit 209 determines whether a distribution of defocus amount of the peripheral region in contact with the pupil region is not less than a predetermined range. Here, the reason why the variation of the distribution of defocus amount in the peripheral region in contact with the pupil region is determined will be described. As shown in FIG. 14, a case where a face of a person as an object faces sideways will be considered. In this case, since the position of the pupil moves to the end portion of the face region, the background enters the pupil region, and if a perspective conflict with the background occurs, there is a possibility that the focus detection result has a rear- focused state. As a result, the variation in the defocus amount in the peripheral region in contact with the pupil region is large, and the histogram of the peripheral region of the pupil region shows a tendency to the rear-focused state in the pupil priority main frame selection processing which will be described later with reference to FIG. 11, therefore the selected main frame is also the rear-focused state.

Further, when a movement is made such that the face is gradually turned from the front facing state, frames with a perspective conflict gradually increase, so that the focus detection result gradually becomes the rear-focused state on the infinite distance side, and when the object gradually moves away, erroneous detection is performed, and more rear-focused AF control is performed.

In order to avoid the above-described situation, when the distribution of defocus amount around the pupil region is not less than the predetermined range in step S1002, the system control unit 209 determines that the variation in the defocus amount around the pupil region is large due to the face changing to a sideways state, and limits the range of the main frame selection region. In the present embodiment, when the variation in the defocus amount around the pupil region is large, the control unit 209 skips step S1003 and advances the processing to step S1004 so as not to add the pupil region to the main frame selection region. When the distribution of defocus amount around the pupil region is less than the predetermined range in step S1002, the control unit 209 determines that the face does not change to the sideways state and the variation in the defocus amount around the pupil region is small, and advances the processing to step S1003.

In the detected object main frame selection processing performed in step 8804 of FIG. 8, since it is determined that the pupil region is not detected in step S803, the processing of steps S1002 and S1003 for limiting the range of the main frame selection region is not performed.

As described above, according to the present embodiment, when the variation in the defocus amount around the pupil region is large, the main frame selection region is changed so that the peripheral region of the pupil region is excluded from the main frame selection region for generating a histogram in step S903 of FIG. 9 which will be described later. Therefore, the peripheral region of the pupil region is selected as the main frame, and a state in which a perspective conflict with the background occurs can be avoided.

In the moving image shooting mode, the main frame selection region may be changed depending on the following conditions.

(1) During a servo AF in a moving image shooting mode;

(2) During a pupil priority AF; and

(3) A rear-focused state of a pupil region is not less than a predetermined rear- focused state or difference between the peak value of the histogram and the defocus amount of the pupil region is not less than a predetermined value.

When the above conditions 1 and 2 are met, the infinite distance side is limited (narrowed) with respect to the depth range of the still image shooting mode, the closest distance side is alleviated (widened), and the main frame selection region is changed from the pupil region to a region where the histogram in the face region is maximized. By widening the depth range on the closest distance side, it is detected that the face region becomes the rear-focused state than the pupil region.

In condition 1, for the sake of that even if a perspective conflict with the background occurs in the still image, the in-focused images so far is not wasted, but if a perspective conflict with the background occurs in the moving image, there is a possibility that the entire moving image cannot be used, and in the moving image in which a person gradually turns the face backward, it is desirable that the back of the head is in focus.

In conditions 1 and 2 (the pupil priority AF in the servo AF in the moving image shooting mode), for the sake of that when the pupil region has the tendency to the rear focused state, the infinite distance side is limited (narrowed) with respect to the depth range of the still image shooting mode, and the closest distance side is relaxed (widened), and the main frame selection region is changed from the pupil region to an region in which the histogram in the face region is maximized thereby reducing the effect of a perspective conflict, and the focus position is stabilized by focusing on the face region thereby reducing the effect of a perspective conflict with the background.

In addition, the main frame selection region may be changed depending on the followings in the moving image shooting mode and the still image shooting mode

- The Pupil priority AF in the moving image shooting mode and the pupil priority AF in the still image shooting mode

- During a live view in the moving image shooting mode and during a live view in the still image shooting mode

In addition, the main frame selection region may be changed depending on the followings in the moving image shooting mode.

- During a moving image recording and a shooting standby

In addition, the main frame selection region may be changed depending on the followings in the still image shooting mode.

- Binocular recognition and single-eye recognition

- Angle of face

In step S1004, the system control unit 209 determines whether a face is detected as the specific region of the object detected by the object detection unit 211. When a face is detected, the system control unit 209 advances the processing to step S1005. When a face is not detected, the system control unit 209 advances the processing to step S1006.

In step S1005, the system control unit 209 adds a face region as the main frame selection region, and advances the processing to step S1006. In step S1006, the system control unit 209 determines whether a whole body is detected as the specific region of the object detected by the object detection unit 211. When a whole body is detected, the system control unit 209 advances the processing to step S1007. When a whole body is not detected, the system control unit 209 terminates the processing and advances the processing to step S902 of FIG. 9. In step S1007, the system control unit 209 adds a whole body region as the main frame selection region, terminates the processing, and advances the processing to step S902 of FIG. 9.

Referring back to FIG. 9, in step S902, the system control unit 209 determines whether the number of AF frames including the main frame selection region decided in step S901 is equal to or larger than a threshold. When the number ofAF frames included in the main frame selection region is equal to or larger than the threshold, the system control unit 209 advances the processing to step S903. When the number of AF frames included in the main frame selection region is smaller than the threshold, the system control unit 209 advances the processing to step S909. In the present embodiment, the AF frame with its center included in the main frame selection region is regarded as the AF frame including the main frame selection region. However, the present disclosure is not limited to this example. For example, the AF frame including at least a part of the main frame selection region or the AF frame that overlaps the main frame selection region by a predetermined percentage or more may be regarded as the AF frame including the main frame selection region.

In step S903, the system control unit 209 classifies the defocus amount calculated for each AF frame including the main frame selection region by a predetermined depth, generates a histogram of the number of AF frames at the AF frame position illustrated in FIG. 15, and advances the processing to step S904.

In step S904, the system control unit 209 determines whether the peak value (the number of AF frames) of the histogram generated in step S903 is equal to or larger than a predetermined value (predetermined number). When the peak value is equal to or larger than the predetenined value, the system control unit 209 advances the processing to step S905. When the peak value is smaller than the predetermined value, the system control unit 209 advances the processing to step S909. In the present embodiment, the maximum number of AF frames in the histogram is normalized by the total number of AF frames and converted into to a ratio. The obtained value is used as the peak value (bin).

In step S905, in order to select a main frame from the main frame selection region decided in step S901, the system control unit 209 starts loop processing for all AF frames including the main frame selection region.

In step S906, the system control unit 209 determines whether the AF frame of the processing target is the AF frame included in the bin indicating the peak value of the histogram. When the AF frame of the processing target is the AF frame included in the bin, the system control unit 209 advances the processing to step S907. When the AF frame of the processing target is not the AF frame included in the bin, the system control unit 209 repeats the loop processing for another AF frame.

In step S907, the system control unit 209 determines whether the AF frame of the processing target satisfies a condition that it is closer to the center of the main frame selection region than the currently selected main frame. When the condition is satisfied, the system control unit 209 advances the processing to step S908. When the condition is not satisfied, the system control unit 209 repeats the loop processing for another AF frame. The center of the main frame selection region may be, for example, the center of the maximum width of the main frame selection region in each of the horizontal direction and the vertical direction, or may be the centroid of the main frame selection region.

In step S908, the system control unit 209 updates the main frame to the AF frame closer to the center of the main frame selection region, and repeats the loop processing for another AF frame. By repeating the loop processing, from the AF frames included in the bin, the AF frame closest to the center of the main frame selection region can be selected as the main frame. When the loop processing is completed, the system control unit 209 terminates the processing, and advances the processing to step S603 of FIG. 6. In step S909, since the processing from step S905 to step S908 cannot be performed for the main frame selection region, the system control unit 209 selects a main frame by center priority main frame selection processing, terminates the processing, and advances the processing to step S603 of FIG. 6. As the center priority main frame selection processing, for example, a method of setting, as a main frame, the AF frame at the center of the object detection region can be used, but a detailed description will be omitted.

### <PUPIL PRIORITY MAIN FRAME SELECTION PROCESSING>

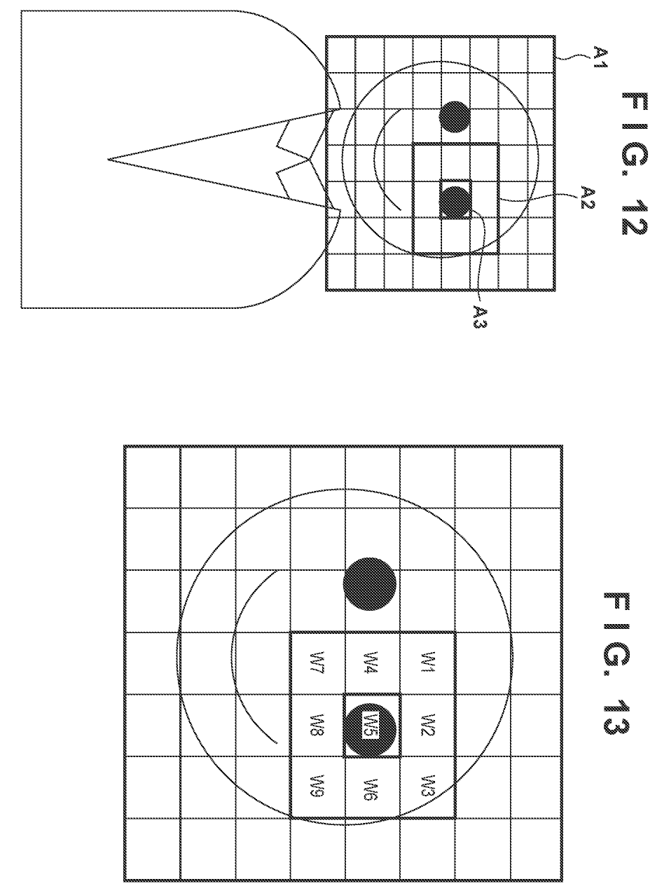

FIG. 11 is a flowchart illustrating the pupil priority main frame selection processing in step S805 of FIG. 8. FIGS. 12 to 14 are views illustrating the pupil priority main frame selection processing.

In step S1101, the system control unit 209 classifies the defocus amount calculated for each AF frame (A1 in FIG. 12) including the face region by a predetermined depth, and generates a histogram.

In step S1102, in order to select a main frame from regions in contact with the pupil region, the system control unit 209 starts loop processing for the peripheral regions in contact with the pupil region. The peripheral regions in contact with the pupil region are, for example, an AF frame (A2 in FIG. 12) with the center of the AF frame included in the pupil region, and AF frames (A3 in FIG. 12) adjacent to the AF frame. However, the present disclosure is not limited to this example, and an AF frame included within a specific distance from the center of the pupil region, or the like may be regarded as the peripheral region.

In step S1103, the system control unit 209 determines whether the bin (target bin), into which the AF frame of the processing target is classified, is different from the bin (selected bin) currently selected as the main frame. When the bin of interest is different from the bin (selected bin) currently selected as the main frame, the system control unit 209 advances the processing to step S1104. When the bin of interest matches the selected bin, the system control unit 209 advances the processing to step S1106. Note that an error value that does not match any bin of the histogram is registered as the initial value of the selected bin to cause the processing to always advance to step S1104 in the first time of the loop processing.

In step S1104, for each of the bins into which the AF frame of the processing target is classified and the selected bin, the system control unit 209 calculates the number of peripheral AF frames by adding the numbers of AF frames in the adjacent bins, and determines which bin has the larger number ofperipheral AF frames. When the bin into which the AF frame of the processing target is classified has the larger number of peripheral AF frames, the system control unit 209 advances the processing to step S1105. When the selected bin has the larger number of peripheral AF frames, the system control unit 209 does not update either the main frame or the selected bin, and repeats the loop processing for another AF frame.

In step S1105, the system control unit 209 sets the AF frame of the processing target to the main frame, sets the bin into which the AF frame of the processing target is classified to the selected bin, and repeats the loop processing for another AF frame.

Here, with reference to FIGS. 13 and 15, the processing in steps S1104 and S1105 will be described.

For example, assume that the current main frame is W1 in FIG. 13, the current selected bin is B4 in FIG. 15, the AF frame of the processing target is W2 in FIG. 13, and the bin into which W2 is classified is B1 in FIG. 15. In this case, the number ofperipheral AF frames of the selected bin is the total value of the number of AF frames of the bins B3, B4, and B5. The number ofperipheral AF frames of the bin into which the AF frame of the processing target is classified is the total value of the number of AF frames of the bins B0, B1, and B2. In the example shown in FIG. 15, the number of peripheral AF frames of the selected bin is larger than the number of peripheral AF frames of the bin into which the AF frame of the processing target is classified. Hence, neither the main frame nor the selected bin is updated.

Note that in step S1104, as the number of peripheral AF frames, the numbers of AF frames of adjacent bins are added. However, depending on the feature of an object, the numbers may not be added, or the number of bins to be added may be changed. For example, in a case where the bin width is set significantly narrow relative to the scale of the depth distribution of the actual face region, it is preferable to increase the number of adjacent bins to be added. To the contrary, in a case where the bin width is set appropriately or wide relative to the scale of the depth distribution of the face region, it is preferable not to add the numbers of AF frames. In step S1106, the system control unit 209 compares the AF frame of the processing target with the current main frame, and determines which one is closer to the center of the pupil region. When the AF frame of the processing target is closer to the center of the pupil region, the system control unit 209 advances the processing to step S1107. When the current main frame is closer to the center of the pupil region, the system control unit 209 does not update the main frame, and repeats the loop processing for another AF frame.

In step S1106, the system control unit 209 compares the AF frame of the processing target with the current main frame, and determines which one is closer to the center of the pupil region. When the AF frame of the processing target is closer to the center of the pupil region, the system control unit 209 advances the processing to step S1107.

When the current main frame is closer to the center of the pupil region, the system control unit 209 does not update the main frame, and repeats the loop processing for another AF frame.

In step S1107, the system control unit 209 sets the AF frame of the processing target as the main frame, and repeats the loop processing for another AF frame.

Here, with reference to FIGS. 13 and 15, the processing in steps S1106 and S1107 will be described.

For example, assume that the current main frame is W1 in FIG. 13, the current selected bin is B4 in FIG. 15, the AF frame of the processing target is W4 in FIG. 13, and the bin into which W4 is classified is B4. In this case, when comparing W1 and W4 to see which one is closer to the center of the pupil region, W4 is closer in FIG. 13. Hence, the main frame is updated to W4 which is the AF frame of the processing target. When the loop processing in step S1105 is completed, the system control unit 209 terminates the processing and advances to step 5603 of FIG. 6.

As described above, according to the present embodiment, it is possible to select an AF frame that is closer to the center of the pupil region and does not greatly deviate from the depth distribution of the face. Accordingly, even if a correct focus detection result cannot be obtained from a specific region of an object that is the target of automatic focus control, it is possible to continuously focus on the specific region.

In the present embodiment, an algorithm for selecting an AF frame around the pupil detection region that does not greatly deviate from the largely detected face. However, the present embodiment can also be applied so as to select, for example, an AF frame around the face detection region that does not greatly deviate from the depth distribution of the whole body. Even when the detected object type changes, if it is possible to hierarchically detect a plurality of specific regions of the object, the present embodiment can be applied to an algorithm for selecting an AF frame around the upper level region that does not greatly deviate from the lower level region.

Further, according to the present embodiment, when the variation in the distribution of defocus amount around the pupil region is large with the face facing sideways as shown in FIG. 14, there is a possibility that an object other than the object to be detected enters the periphery of the pupil region or a perspective conflict with the background occurs. Therefore, it is possible to prevent the pupil region from being added to the main frame selection region, to select an appropriate main frame for the object, and to prevent erroneous detection in which the object gradually moves away.

According to the present disclosure, it is possible to continuously focus on the same object even when an orientation of an object targeted for automatic focus control changes.

### [OTHER EMBODIMENTS]

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024- 104354, filed June 27, 2024 which is hereby incorporated by reference herein in its entirety.

What is claimed is:

1. A focus detection apparatus comprising:
an object detection unit configured to hierarchically detect one or more specific region from an object in a captured image;
a setting unit configured to set focus detection regions divided into a plurality of regions with respect to the specific region;
a focus detection unit configured to detect focus detection information for each focus detection region; and
a decision unit configured to decide a target region for performing an automatic focus operation,
wherein the decision unit
obtains a distribution of defocus amount of the specific region, and
changes a range for obtaining a distribution of defocus amount of a lower level region in a case where a distribution of defocus amount of an upper level region is not less than a predetermined range, when deciding the target region included in the upper level region based on the distribution of defocus amount of the lower level region in the specific region.

2. The apparatus according to claim 1, wherein
the decision unit limits the range for obtaining the distribution of defocus amount in the lower level region so as not to include the range for obtaining the distribution of defocus amount in the upper level region.

3. The apparatus according to claim 2, wherein
the decision unit limits the range for obtaining the distribution of defocus amount in the lower level region in a case where the distribution of defocus amount of the upper level region is not less than a predetermined range with the target region is set.

4. The apparatus according to claim 1, wherein
in a case where the object detection unit detects the lower level region and the upper level region, the decision unit decides the target region from a peripheral region of the upper level region based on the distribution of defocus amount of the lower level region.

5. The apparatus according to claim 4, wherein
the decision unit decides the target region based on a distribution of defocus amount of the peripheral region of the upper level region and the distribution of defocus amount of the lower level region.

6. The apparatus according to claim 5, wherein
the decision unit sets the target region based on a result of comparison of peak values of distributions of defocus amount of the peripheral regions of the upper level region.

7. The apparatus according to claim 5, wherein
the decision unit decides a focus detection region of the upper level region based on a center of the upper level region and a position of the peripheral region of the upper level region.

8. The apparatus according to claim 1, wherein
in a case where the object detection unit does not detect the lower level region and the upper level region, the decision unit generates a distribution of defocus amount of a region of the lower level region in which the number of focus detection regions is not less than a threshold, and
decides the target region from the regions in which a peak value of the generated distribution of defocus amount is not less than a predetermined value.

9. The apparatus according to claim 8, wherein
the decision unit decides the target region based on a current target region and a position of the lower level region.

10. The apparatus according to claim 1, wherein
the specific region includes at least one of a first region, a second region including the first region, and a third region including the second region.

11. The apparatus according to claim 1, wherein
the distribution of defocus amount is a histogram of the number of focus detection regions obtained by classifying the defocus amount by each of predetermined depths.

12. The apparatus according to claim 1, wherein
the object is one of a person and an animal, and the specific regions are a pupil, a face, and a whole body of one of the person and the animal.

13. The apparatus according to claim 12, wherein
the upper level region is a pupil, and the lower level region is one of a face and a whole body.

14. An image capture apparatus comprising:
an image capture unit;
a focus detection apparatus; and
a focus control unit configured to execute an automatic focus operation with respect to a target region,
wherein the focus detection apparatus comprises
an object detection unit configured to hierarchically detect one or more specific region from an object in a captured image;
a setting unit configured to set focus detection regions divided into a plurality of regions with respect to the specific region;
a focus detection unit configured to detect focus detection information for each focus detection region; and
a decision unit configured to decide a target region for performing an automatic focus operation,
wherein the decision unit
obtains a distribution of defocus amount of the specific region, and
changes a range for obtaining a distribution of defocus amount of a lower level region in a case where a distribution of defocus amount of an upper level region is not less than a predetermined range, when deciding the target region included in the upper level region based on the distribution of defocus amount of the lower level region in the specific region.

15. The apparatus according to claim 14, wherein
the decision unit changes the range for obtaining the distribution of defocus amount in the lower level region when deciding the target region in a moving image shooting mode.

16. The apparatus according to claim 14, wherein
the distribution of defocus amount is a histogram of the number of focus detection regions obtained by classifying the defocus amount by each of predetermined depths, and
the decision unit narrows an infinite distance side and widens a closest distance side for a depth range of a still image shooting mode, and decides the target region from the lower level region of which the histogram is maximum.

17. A focus detection method comprising:
hierarchically detecting one or more specific region from an object in a captured image;
setting focus detection regions divided into a plurality of regions with respect to the specific region;
detecting focus detection information for each focus detection region; and
deciding a target region for performing an automatic focus operation,
wherein in the deciding, a distribution of defocus amount of the specific region is obtained, and
a range for obtaining a distribution of defocus amount of a lower level region is changed in a case where a distribution of defocus amount of an upper level region is not less than a predetermined range, when deciding the target region included in the upper level region based on the distribution of defocus amount of the lower level region in the specific region.

18. A non-transitory computer-readable storage medium storing a program for causing a computer to function as a focus detection apparatus comprising:
an object detection unit configured to hierarchically detect one or more specific region from an object in a captured image;
a setting unit configured to set focus detection regions divided into a plurality of regions with respect to the specific region;
a focus detection unit configured to detect focus detection information for each focus detection region; and
a decision unit configured to decide a target region for performing an automatic focus operation,
wherein the decision unit
obtains a distribution of defocus amount of the specific region, and
changes a range for obtaining a distribution of defocus amount of a lower level region in a case where a distribution of defocus amount of an upper level region is not less than a predetermined range, when deciding the target region included in the upper level region based on the distribution of defocus amount of the lower level region in the specific region.
